(19) United States
(12) Patent Application Publication
(10) Pub. No.: US 2026/0228601 A1
(43) Pub. Date: Aug. 6, 2026

(54) Safety monitoring

(71) Applicant: SICK AG, Waldkirch (DE)

(72) Inventor: Markus HAMMES, Waldkirch (DE)

(21) Appl. No.: 19/042,446

(22) Filed: Jan. 31, 2025

(51) Int. Cl. G06N 20/00; G06Q 50/26

(52) U.S. Cl. CPC G06N 20/00; G06Q 50/265

(57) ABSTRACT

A method for a distributed training of a common AI model for a safety monitoring of an operating zone is provided, wherein at least one respective first sensor generates sensor data by monitoring a respective operating zone at a plurality of locations; a respective classical safety system monitors the respective operating zone by at least one respective second sensor at a respective location of the plurality of locations and carries out a safety evaluation; and a respective local AI model is trained with the sensor data and the safety evaluation of the respective location. In this respect, the training results of the local AI models are transmitted to an orchestration server and the orchestration server generates or improves the common AI model using the training results.

The invention relates to a method and to a safety system for a distributed training of a common AI model for a safety monitoring of an operating zone.

Today's safety engineering is based on classical evaluations. Classical is here the opposite of methods of machine learning or artificial intelligence (AI). One aspect that stands in the way of certification is the lack of legal and normative principles. In safety engineering high standards are made on reliability and are fixed in relevant standards that do not yet permit functions implemented by means of artificial intelligence. Safety standards such as the standard EN13849 for machine safety and the machine standard EN61496 for electrosensitive protective equipment (ESPE) require measures such as safe hardware or functional monitoring processes by which it is ensured that hardware defects are discovered and the evaluation runs as it was programmed. In safeguarding logic, very simple functions are prevalent that can be implemented with deterministic analytical algorithms. A known example for this is a monitoring of protected fields that may not be entered by an operator. On the other hand, there are tasks, particularly in the field of image evaluation, such as object classification and especially person detection that can only be resolved at all using artificial energy. Such functions are consequently not available in technical safety applications.

In addition to the more formal hurdles, there are concrete technical challenges for a desired implementation of safe functions by means of artificial intelligence or of an AI model. Common training approaches require a large number of training examples at a central location. Large amounts of data from very different areas of use have to be collected, annotated, and evaluated with respect to their completeness and balance for this purpose before the use of the AI model. The effort is in particular substantial with respect to the high reliability demands. Particularly valuable training data are acquired directly from the later application environment. It is, however, typically an operational production environment or logistics environment from which data are reluctantly released, to the extent that this would be permissible at all, for reasons of data protection. And even if these data were available, a retroactive annotation would be extremely laborious and would require an exact knowledge of the respective detection situation of the data.

After the training of an AI model, a demonstration of function is required in technical safety applications that achieves a reliability comparable with the current safety standards and that thus goes far beyond the normal validation of a conventional AI model. A theoretical proof using evaluation algorithms is not possible due to the black box nature of an AI model. Release tests used instead can take place under laboratory conditions in some cases, but it must ultimately be expected that tests also have to be performed on site. This in turn requires access to the operating zones which is again frequently opposed for reasons of secrecy and in any case a substantial additional effort.

The problem of data drift must furthermore be considered. Even if the training data represent a complete and balanced representation of the real operating environment at the time of training, the reliability of the AI model can deteriorate thereafter due to creeping changes in the environment. The argument here would conventionally be stable detection features that are not affected by data drift. This does not work with an AI model because the training looks for the features itself and they are not known at all.

The concept of federated learning is known in the field of machine learning. In this process, the training takes place decentrally in a plurality of nodes that make up a robust model together in this manner. Federated learning was not developed for safety engineering and has also not been proposed for it to date.

The sensors used in safety engineering are frequently optoelectronic sensors and increasingly specifically include cameras, more recently also 3D cameras. There are 3D cameras in different technologies, including a time of flight process, a stereoscopic process, and a projection process or plenoptic cameras. As already mentioned, relatively simple concepts are pursued here such as the demand that protected fields remain free and even such classical image processing methods are already hugely complex in implementation. EP 3 859 382 A1 proposes a radio location system that localizes a radio transponder worn by a person. It is compared with the position determination of a radar, ultrasound sensor, or laser scanner. A safe person recognition is therefore only possible after this sensor fusion and the evaluation remains fully classical.

DE 10 2017 105 174 B4 discloses a method of generating training data for an artificial neural network in which the evaluation of recorded image data as safety critical or not safety critical is automatically carried out by a safe sensor. However, this does not per se solve any of the initially named problems since such training data would still have to be collected centrally, the safe function of a trained neural network would have to be validated, and the neural network would not be robust with respect to data drift.

A deep neural network is used for the classification of objects for an autonomous vehicle in US 2021/0063578A1 . In this respect, labels of a camera on LiDAR data are transmitted. Federated training is mentioned once in a long list of training processes without reference ever being made to it again.

US 2022/0332335 A1 deals with data analysis for vehicles using neural networks and federated learning.

It is therefore the object of the invention to provide an improved training method for an AI model usable in technical safety applications.

This object is satisfied by a method and by a safety system for a distributed training of a common AI model for a safety monitoring of an operating zone in accordance with the respective independent claims. The terms safe and safety mean that measures have been taken to control errors up to a specified safety level. Such safety levels are differentiated, for example, as SIL 1 to SIL 4 (safety integrity level) or PL a to PL e (performance level). For the classical case, this means the observation of conditions of a relevant safety standard for machine safety or for electrosensitive protective equipment. There are not yet any such standards for implementations of safety functions using artificial intelligence; demonstrations of equivalent reliability have to be documented. An AI model is an evaluation block or computer program to evaluate input data using a method of machine learning, in particular a deep neural network. Federated learning is known per se as a concept outside safety engineering and has been briefly explained in the introduction. A consolidated AI model that is produced by the distributed training is called a common AI model to distinguish it from local AI models at the different locations of the distributed training. An operating zone comprises at least one machine or another hazardous zone or its environment. The operating zone may, however, by all means be more extensive; for example, may comprise production lines, aisles, and racks, up to the so-called plant level, that is a whole factory or logistics center, having a large number of machines, hazardous points, sensors, and persons potentially moving therebetween. The operating zone is safety related in the sense that in principle accidents with persons are possible and therefore have to be prevented.

At least one first sensor monitors the operating zone at a plurality of locations therein and generates corresponding sensor data. This corresponds to the distributed training that thus takes place decentrally at the plurality of locations. A location is respectively associated with one of the decentral nodes as part of the federated learning. The AI model should work with the sensor data of the first sensor so that they are preferably extensive sensor data such as image data of a camera or point clouds of a laser scanner or of a 3D camera. In this respect, there can be a plurality or, depending on the complexity, in particular at the plant level, a very large number of first sensors, also of mutually different sensor principles, at one location.

A classical safety system likewise monitors the operating zone at the plurality of locations. The classical safety system has at least one second sensor for this purpose; a second sensor is accordingly associated with the classical safety system and not the AI model. First and second sensors should ultimately be able to resolve the same safety application, that is carry out a safety evaluation to prevent accidents at the required safety level, but can substantially differ from one another in number, position, and type of the sensor system. The classical safety system acquires a safety evaluation using dedicated algorithms without machine learning or artificial intelligence. The safety evaluation of the classical safety system is used to automatically annotate or label the sensor data of the first sensor for the purpose of use as training examples. It must be emphasized that the first and second sensors designate a role in the association with the AI model or the classical safety system. They can physically be the same sensors, at least In part, for example a camera image classically evaluated, for example, with protected fields, and simultaneously used as sensor data for the AI model.

High-quality annotated training data are thus available at the plurality of locations for a respective local AI model. The goal of the training of the local AI model thus carried out, preferably of a supervised learning, is a separate safety evaluation. The local AI model is preferably not initially productive, in any case as long as it still has to be trained and also thereafter, until it has been certified for safety applications. Alternatively, an already productive local AI model can be subsequently trained with the analog procedure, as explained below. The local AI models are preferably the same as one another with respect to their general architecture and are preferably also initialized the same. They then differ in the course of the training because they are trained using different sensor data of their respective locations.

Up to this point, there are thus respective first sensors, local AI models, and classical safety systems with their second sensors decentrally at the plurality of locations and the local AI models are trained asynchronously in the described manner. It must be repeated that the second sensors may physically coincide with the first sensors, at least in part. The plurality of locations can be close to one another, for instance at adjacent machines; but the training can equally be distributed over different facilities, firms, locations, regions, or even countries and continents.

The invention starts from the basic idea of collecting and consolidating the different local AI models at a central location to thus acquire the common AI model. This coordination and management is called orchestration. For this purpose, the training results of the local AI models are transmitted to a server that is called an orchestration server based on its function. It is not training data that are communicated, but training results. They can, for example, be weights, gradients, or other information on the training results, right up to complete AI models or neural networks. It is only important that the orchestration server receives sufficient information by which a participation in the respective local training progress is possible Reference is additionally made to the literature on federated learning with respect to the question of the information to be communicated and equally to the subsequent consolidation into a common AI model. The common AI model preferably corresponds to the local AI models in its architecture. It can be both first generated from the local AI models and also improved, either by progresses of a subsequent training of local AI models or by inclusion of further local AI models.

The method is a computer implemented method that runs, for example, in processing units of the sensors and/or processing units connected thereto, and on the orchestration server.

The invention has the advantage that requirements for AI based safety functions are created by the distributed training. A technological ecosystem is produced to implement AI functions in the context of functional safety. It comprises complex sensor data such as 3D image data and complex functions such as a safe object classification and it is scalable both with respect to the number of participating locations and to the size of the respective local safety application, up to plant level safety systems. Since only training results are communicated and not, for example, image data of usual training datasets, secrecy interests, personality rights, and data protection are maintained. All three initially discussed problems are addressed within this framework. First, high-quality, annotated training data are automatically acquired in a wide spectrum of deployment scenarios so that an extremely robust and powerful common AI model is produced. Second, its validation corresponding to the strict technical safety standards become possible with practically the same mechanisms (on-premise validation, field test) where correspondingly annotated sensor data then act as a ground truth dataset. A requires safety level is thus achieved despite the black box nature of the common AI model. Third, a continuous monitoring for defect discovery is made possible to counteract a data drift, i.e. a gradual change of reality with respect to past training data and a degradation of the common AI model associated therewith.

The orchestration server preferably transmits the common AI model to at least one location where it in particular acts as a local AI model. Transmitting an AI model means that sufficient information is transmitted to understand the AI model, no matter in what form. The common AI model generated from the training results of the local AI models is thus restored to the locations and preferably replaces the previous local AI model there. The location thus profits from the training results of the other locations. It is alternatively also conceivable to send the common AI model to a location that did not participate in the distributed training. It is assumed here that the locations of the training were extensive enough to permit a generalization to further locations. The local AI model is thus identical to the common AI model at the location after the transmission. This may then change again in the further course due to local adaptations or subsequent local training.

The local AI model preferably evaluates sensor data recorded by the first sensor there at at least one location to carry out a safety evaluation and in particular to introduce a safety measure on recognition of a hazard. The local AI model is here the common model obtained from the orchestration server or is at least based thereon. It is thus able to (also) take over the productive operation or to do it at least on a trial basis, for example for a validation. A safety measure is then in particular introduced in productive operation when the safety evaluation recognizes a hazard. This can, for example, be the stopping or slowing down of a machine or the introduction of an evasive movement. The method for the distributed training is thus an initial or intermediate step of a method of monitoring a respective operating zone at the respective locations using the common AI model or a spin-off or a copy thereof as a local AI model.

The classical safety system preferably furthermore carries out a safety evaluation at least temporarily at the at least one location. There can in particular be reference locations at which the classical safety system remains installed and in operation at least at times, while it is possibly dismantled or permanently deactivated at other locations and a classical safety system was and is never present at yet other locations The continued safety evaluation by the classical safety system after a common AI model had already been restored as a local AI model enables different embodiments that will now be explained.

The safety evaluations of the classical safety system and of the local AI model are preferably not compared with one another. A first conceivable purpose for this is a check of whether the local AI model from sensor data still correctly manages the current real situation. If the classical safety system and the local AI model do not agree, a data drift is assumed. This can be a trigger to subsequently train the local AI model or to require an improved common local AI model on the orchestration server.

A safety measure is preferably initiated when the classical safety system or the local AI model recognizes a hazard. It would be irresponsible not to respond to a recognized hazard even if the classical safety system and the local AI model do not agree. Such situations are moreover particularly valuable training examples. If the local AI model is furthermore not solely responsible for safety, which it could be after the distributed training, the diverse redundancy of the monitoring increases the achievable safety level.

The local AI model is preferably validated using the comparison. The local AI model has been produced from the common AI model at this time so that the latter is actually validated, and preferably at a plurality of locations. In other words, field tests of the common AI model are carried out at at least one location. As in the training, the classical safety system generates a safety evaluation on sensor data of the first sensor. This is now, however, not used for a training, without precluding this possibility as part of a subsequent training, but specifies the expectation for the safety evaluation (ground truth) of the AI model. Such a field test takes place at least largely automatically so that the operating zone still remains free from the access of persons, for example of the operator of the orchestration server, possibly not desired there for the carrying out of the field test.

The common AI model is preferably optimized in an iterative process in that at least one local AI model is subsequently trained with the sensor data and the safety evaluation of the respective location, training results of the at least one local AI model are transmitted to the orchestration server and the orchestration server improves the common AI model using the training results. This describes a further iteration of the initial training that can also be repeated multiple times to further optimize the common AI model and in particular to revise it with respect to data drift. The respective safety evaluation that is associated with a training dataset as a label originates from a classical safety system, used in parallel at least temporarily, of the local AI model or from another source such as a manual annotation. The optimizations can take place in parallel with an already productive operation of a local AI model. The respective subsequent local training preferably takes place using a non-productive copy of the local AI model. If sufficient additional training data have then arrived at sufficient locations, the orchestration server generates a new version of the common AI model and restores it to the locations, preferably after a repeat validation and certification. Certain conditions can be directly made for a subsequent training, for instance with respect to the first sensors, their arrangement, the operating zones, object properties, applications, environmental influences, and the like to widen the training base or to give it a desired direction.

The first sensor preferably generates image data. There is an abundance of powerful architectures and learning processes that can thus be utilized, in particular in the case of an AI model that is implemented as a neural network. A 3D camera is also conceivable in addition to a conventional camera. The first sensor is preferably a safe sensor in the sense that its image data are delivered correspondingly reliable to a required safety level. Alternatively, however, only the combination of the first sensor and the AI model can achieve the required safety level with a first sensor that is not safe on its own.

The classical safety system preferably has a radio location system (UWB, ultrawide band). Such a system is described, for example, in EP 3 859 382 A1 named in the introduction. The classical safety system is, however, not restricted to this; it is only important that a safety evaluation is delivered on the sensor data of the first sensor, for which purpose, for example, also a safety camera or a safety laser scanner, are suitable, in particular with protected field monitoring and, depending on the installation, also simpler safer sensors such as safety light grids or door switches.

The safety evaluation preferably comprises a safe object classification, in particular a person recognition. There is no generally functional classical image evaluation for this. Ai-based solutions have previously not been compatible with functional safety, inter alia because extensive training data from relevant safeguarding situations are lacking. It is exactly this weakness that the invention can inter alia remedy. A classical safety system with person recognition can, for example, be based on a transponder worn by the person or there is a monitored access restriction. Such aids can then be dispensed with later when the AI model has learnt the safe person recognition. A safe object classification is only one example of a safe function, albeit an important one. When the classical safety system provides a different safe function such as a safe localization or movement tracking, this can likewise be learnt and such safe functions can also be combined, for instance a safe person tracking. The combination as a tag-based radio location system in accordance with EP 3 859 382A1 , by which the safe person recognition is implementable, is particularly preferred. In this respect, as a rule, an optical gate is required, i.e. a 3D camera system to monitor the access of persons that do not wear a tag and whose image data can then be used in a dual role of the 3D camera system as part of the classical system and as a supplier of sensor data for the AI model.

The safety system in accordance with the invention comprises an orchestration server and a plurality of nodes at a respective one of a plurality of locations, with the orchestration server having a server processing unit and a first communication interface and the nodes having a respective AI processing unit and a second communication interface so that AI models or training results of AI models can be transmitted over the communication interfaces. At least one respective first sensor for the generation of sensor data by monitoring a respective operating zone of the location and a respective classical safety system for the monitoring of the respective operating zone having at least one respective second sensor and for carrying out a safety evaluation are provided at the locations. The respective AI processing unit is configured to train a respective local AI model with the sensor data and the safety evaluation of the respective location and to transmit training results of the local AI models to the orchestration server, wherein the server processing unit is configured to generate or to improve the common AI model using the training results. In other words, the orchestration server and the nodes perform the method in accordance with the invention and this is possible in all the described embodiments.

The invention will be explained in more detail in the following also with respect to further features and advantages by way of example with reference to embodiments and to the enclosed drawing. The Figures of the drawing show in:

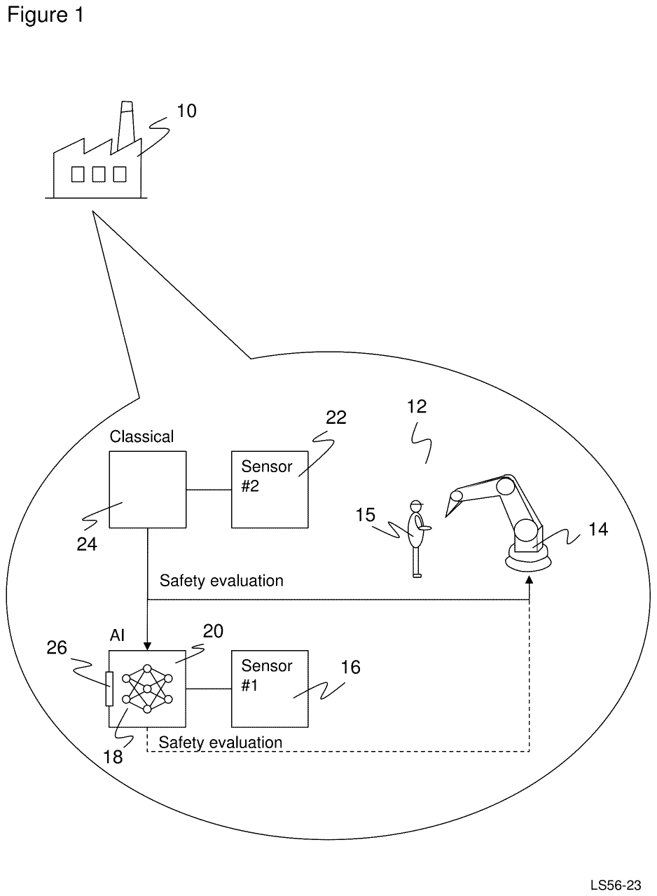

FIG. 1 a schematic representation of a location having a monitored operating zone that represents a nose of a distributed training;

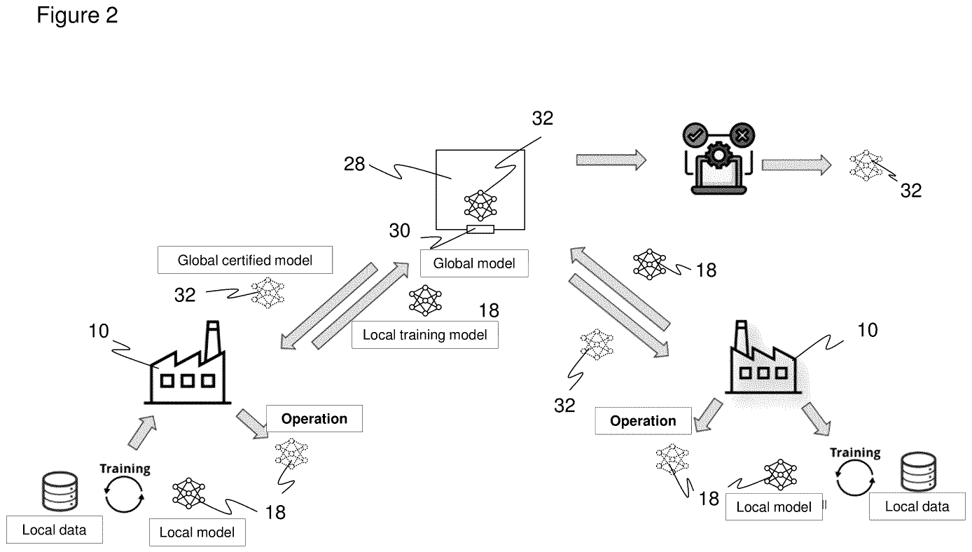

FIG. 2 an overview representation of a distributed training having an orchestration server and a plurality of nodes;

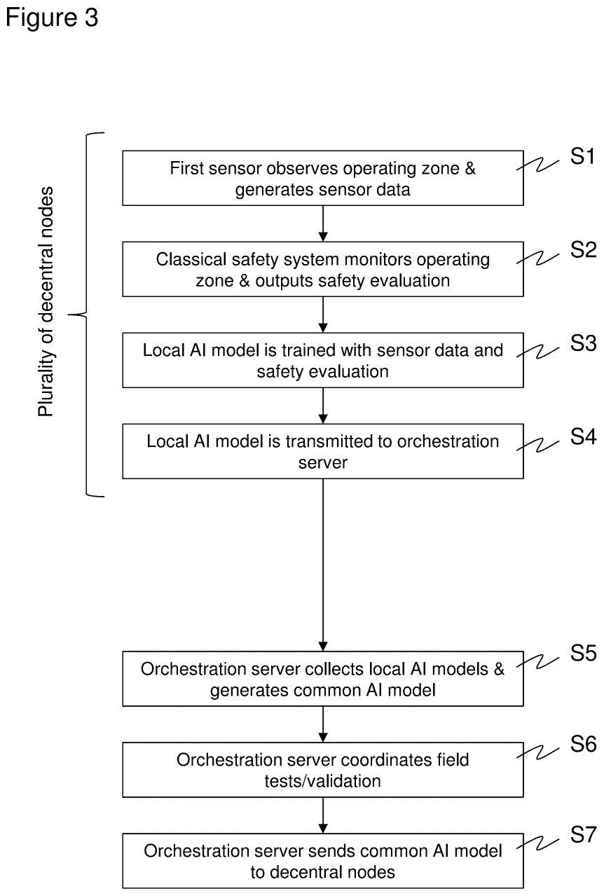

FIG. 3 an exemplary flowchart of an initial distributed training of a common AI model;

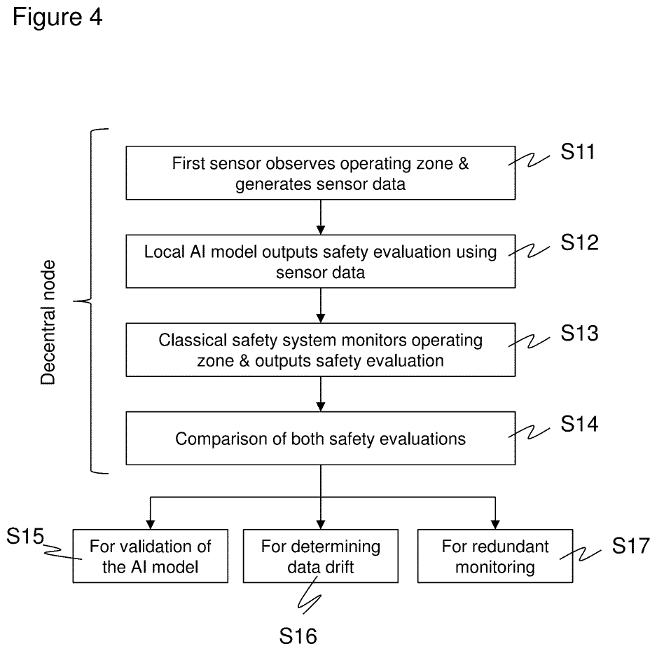

FIG. 4 an exemplary flowchart of a dual safety evaluation having a classical safety system and an AI model for validation, fixing of data drift, and/or diversely redundant monitoring;

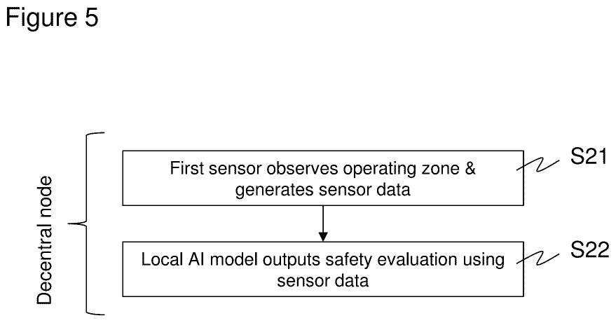

FIG. 5 an exemplary flowchart of a safety monitoring by the trained AI model; and

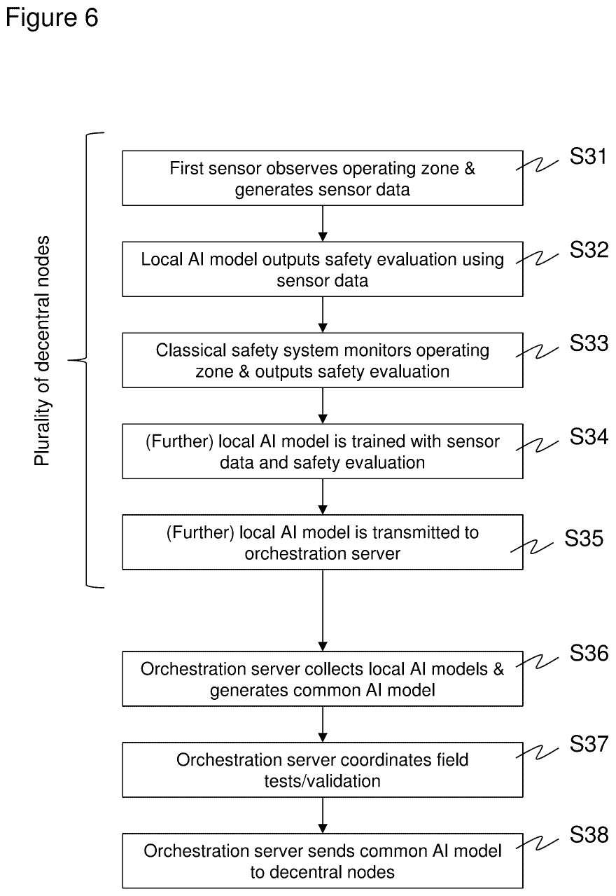

FIG. 6 an exemplary flowchart for a distributed training of the common AI model.

FIG. 1 shows a schematic representation of a location summarized by a factory symbol having an operating zone 12. At least one hazardous point or machine 14, represented by a robot arm here, is located in the operating zone 12. It is the object of the safety monitoring described here to prevent accidents between the machine 14 and a person 15 possibly present in the operating zone 12. In the end effect, a first sensor 16 having an evaluation by a local AI model 18, in particular a (deep) neural network, in an integrated or connected AI processing unit 20, should be responsible or should at least participate therein for this purpose. The local AI model 18, however, first has to be trained for this task and, since it is a question of safety, validated or certified corresponding to the desired safety level.

To acquire annotated training data for the local AI model 18, a classical safety system having a second sensor 22 and a classical processing unit 24 is additionally provided. The classical safety system resolves the safety application in a manner known per se. In this respect, a safety evaluation is carried out that, on the one hand, acts on the machine 14 on a recognition to eliminate the danger, that is cause to stop, to brake, to evade or whatever is appropriate to avoid an accident. The safety evaluation, on the other hand, acts as a label for sensor data of the first sensor 16 recorded at the same time so that its sensor data automatically become annotated training data for the local AI model 18.

FIG. 1 shows the first sensor 16 and the second sensor 22 as respectively separate units. They are actually frequently different devices in practice. It is, however, initially only a question of the functional roles: the first sensor 16 is associated with the AI model 18, the second sensor 22 with the classical safety system. Physically, the same device can satisfy both roles, for example a camera or a 3D camera that is classically evaluated within the safety system and simultaneously delivers the image data for the AI model.

The invention is based on a distributed training, in particular a federated learning. On completion of the training, for instance after the elapse of a specified duration or after reaching a specified number of training datasets, the local AI model 18 is not yet set to productive. Information that forwards the training progress that is,, for example, weights of a neural network or gradients of a residual error, is rather output to an orchestration server over an interface 26. Local AI models 18 of a plurality of locations 10 are collected there and are consolidated in a common AI model that is then again transmitted to the locations 10 and/or to further locations. The distributed training will be explained more exactly below. In the terms of federated learning, the locations 10 are called nodes, in particular the AI processing unit 20.

The AI processing unit 20 and the classical processing unit 24 are not fixed to specific hardware. There can rather even be only one hardware module or other arbitrary hardware modules that provide the required capacities for processing, communication, and memory. Examples are digital processing modules such as a microprocessor or a CPU (central processing unit), an FPGA (field programmable gate array), a DSP (digital signal processor), an ASIC (application specific integrated circuit), an AI processor, an NPU (neural processing unit), a GPU (graphics processing unit), a VPU (video processing unit), or the like and equally a computer of any desired type, including notebooks, smartphones, tablets, a (safety) controller, and also a local network, an edge device, or a cloud. There is also a large selection with respect to the communication links, for instance Ethernet, I/O-Link, Bluetooth, WLAN, Wi-Fi, 3G/4G/5G, and in principle any industry suitable standard.

The representation of the location 10 is simplified and purely exemplary. The operating location 12 can be substantially more extensive and more complex and can comprise a plurality of machines 14 such as machining tools, robots, AGVs, or other transport systems and the like. Not only individual sensors, but rather a plurality of first sensors 16 and second sensors 22 are correspondingly required. This goes up to a plant level safety system, a networked safety system for a whole factory building or logistics building in which the sensor information is collected in real time, is evaluated in a technical safety manner, and is used for the control, optimization, risk reduction in the operating zone 12. The described basic principles with an annotation using a safety evaluation of the classical safety system and a corresponding distributed training of a local AI model 18 are also maintained in this increased local complexity.

A variety of first sensors 16 and second sensors 22 can correspondingly be used. As an example, the first sensor 16 is a camera or a 3D camera so that the local AI model 18 evaluated image data. It is advantageous in a 3D detection to separate the detected objects with the aid of distance values from a background that is not changeable or only changeable a little. This facilitates the further processing and the generalization to other locations 10. The classical safety system can be a radio location system such as in EP 3 859 382A1 , for example. The valuable safe function of person recognition can thus in particular be trained that the classical safety system performs using transponders and that learns to then apply the local AI model 18 to image data so that the transponders can preferably be dispensed with after the training. Other classical safety systems are usable, in particular those that likewise make person recognition possible. A passage door with a release by unique identification marks can be named as an example. It must be emphasized in this connection that the first sensor 16 and the second sensor 22 do not necessarily have the same detection zones despite resolving the same safety function. For example, the first sensor 16 can observe the machine 14; however, the second sensor 22 can observe the only passage door to this machine 14 since it is thus likewise safely determined, albeit indirectly, whether there is a person in the vicinity of the machine 14.

FIG. 2 shows an overview representation of a distributed training having an orchestration server 28 and a plurality of nodes or locations 10 The orchestration server 28 has a communication interface 30 and a service processing unit that is not separately shown and to whose hardware the same applies accordingly as to the previously described processing units 20, 24. The locations 10 have the structure described with respect to FIG. 1; the routine of the distributed training is illustrated on a functional level here in FIG. 2. The distributed training will now first be described in a total overview; specific portions will then subsequently be explained in more detail with reference to FIGS. 3 to 6.

Initially, local AI models are trained at the locations 10, that is at the bottom left and right in FIG. 10, in the manner explained with respect to FIG. 1. The local AI model can already be initially pretrained so that the training on site primarily serves an adaptation to the circumstances there. The training data can be acquired and annotated in an automated manner alongside normal operation and remain as such at the locations 10. At this point in time, the local AI model has still not yet been released and runs, so-to-say, non-productively alongside. This is shown by a darker color of the AI model, unlike the productive AI models released later.

After completion of the local training, the optimizations resulting therefrom are transmitted to the orchestration server 26 that has a communication interface 30 for this purpose. Unlike the training data themselves, the information transmitted to the orchestration server 28 does not allow any conclusions on the operating location 12 or even on specific persons 15 and such information can therefore be forwarded without problem. The orchestration server 28 combines the training results of the different locations 10 in a global or common AI model 32 (consensus). The common AI model 32 can then be centrally checked and certified. It is subsequently restored to the locations 10 and can be set to productive there. Field tests can be carried out with the common AI model 32 on site 10 as an intermediate step prior to the certification that is subsequently certified and restored for productive operation.

It is conceivable to also transmit the common AI model 32 to locations 10 that did not participate in the distributed training or, conversely, only to use some of the locations 10 for training without restoring the common AI model 32 to them. The distributed training can be iteratively repeated to expand or improve the common AI model 32 or to take data drift into account. The federated learning is suitable in the technical safety application because it interlinks a central development and optionally a certification with decentral deployment areas or locations 10 that differ at least in part. A constant flow and backflow of information and aspects such as the monitoring of data drift or the large scale performance of field tests can thereby be implemented.

FIG. 3 shows an exemplary flowchart to observe the initial distributed training of the common AI model 32 even somewhat more exactly. The responsibility for safety is solely that of the classical safety system in this phase. In a step S1, the first sensor 16 observes the operating zone 12 and generates sensor data. In parallel with this, in a step S2, the classical safety system also monitors the operating zone 12 by the second sensor 22 and outputs a safety evaluation. In a step S3, the local AI model 18 is trained as a label or annotation with the sensor data and the associated safety evaluation of the classical safety system. This training of the steps S1 to S3 is continued in accordance with a specification, for instance a certain time duration or a number of training steps. The local AI model 18 can be initialized with arbitrary values or random values or it has already been pretrained, for example with images of an arbitrary source of persons and other objects in the case of person recognition to be learned. In a step S4, the trained local AI model 18 or a piece of information that allows the training progress to be tracked is transmitted to the orchestration server 28. The steps S1 to S4 are carried out at a plurality of locations 10 or in a plurality of decentral nodes.

In a step S5, the orchestration server 28 collects the training progresses of the locations 10 and generates the common AI model 32 from them. The decentral nodes, for example, communicate weights of a neural network or gradients of the residual error. Weights can be averaged, possibly with a different influence, for example depending on the significance of a location 10 or on its application or in dependence on a number of training datasets entered into the respective local training. Gradients that are then offset, for example in a back propagation process on the orchestration server 28 to form new weights of the common AI model 32 can be treated in a similar manner. The contributions of the decentral nodes can be understood as (mini-)batches; the training of the common AI model 32 then works like the known batch learning, with the difference that a larger training dataset is not artificially divided into batches, but the batches are rather contributed from the different locations 10. Further approaches for consolidation in step S5 can be seen from the literature on federated learning.

In an optional step S6, the orchestration server 28 coordinates a validation of the common AI model 32 by field tests, as explained in the following with reference to FIG. 4. To ensure a safety level, the common AI model 32 is certified on the basis of the field tests or other specifications.

In a step S7, the common AI model 32 is transmitted to selected locations 10. They can be the same locations 10 that have contributed local AI models 18 in steps S1 to S4, but some of these locations 10 can be omitted or further locations 10 added. The initial training is thus ended, there are different possibilities that are looked at now as to how the obtained common AI model 32, that is used as a new AI model 18, is treated at the locations 10.

FIG. 4 shows an exemplary flowchart of a dual safety evaluation with a classical safety system and a local AI model 18. In a step S11, the first sensor 16 observes the operating zone 12 and generates sensor data. In a step S12, the local AI model 18, that has been produced from the common AI model 32, outputs a safety evaluation on the sensor data. In parallel with this, in a step S13, the classical safety system also monitors the operating zone 12 by the second sensor 22 and outputs a safety evaluation. In a step S14, the two safety evaluations are compared with one another.

This comparison can now be used alternatively or cumulatively for three purposes. In a step S15, the local AI model 18 and subsequently the common AI model 32 are thus validated by field tests. In this case, the local AI model 18 is preferably not yet in productive use. Due to the safety evaluation of the classical safety system in step S13, the result which the local AI model 18 would have to arrive at is known. A expectation (ground truth) for the validation is now produced in a field test using the same mechanism with which the training data are automatically by the classical safety system in FIG. 3. The comparison results or the results of the field test are preferably transmitted to the orchestration server 28 and are collected from a plurality of locations 10 there. The common AI model 32 can then be certified there in the successful case.

In a step S16, a check is made whether the local AI model 18 still works correctly and has not, for example, significantly lost recognition power due to data drift, for example. In this case, the local AI model 18 can already be in productive use. As with the validation, a correctly working AI model 18 should reproduce the safety evaluation of the classical safety system. Such an online monitoring can also be carried out in an environmentally specific manner for individual production facilities or logistics areas. If data drift is now recognized, a subsequent training can thus in particular take place and, if safety is no longer ensured, a response with a corresponding safety measure can be made.

In a step S17, the parallel use of the local AI model 18 and the classical safety system is utilized for a diversely redundant monitoring. The local AI model 18 is productive in this case, but is not solely responsible for safety, but only in combination with the classical safety system. A higher safety level can thereby be achieved. The triggering of a safety measure typically takes place in a logical OR, i.e. when one of the two systems recognizes a hazard, safeguarding is performed as a precaution. If the two systems do not agree, however, one of them can be decisive and a subsequent check should at least be made of where the lack of agreement arises, for instance by subsequent training.

FIG. 5 shows an exemplary flowchart of a safety monitoring by the trained common AI model 32 that was transmitted to one of the locations 10 as a local AI model 18. In a step S21, the first sensor 16 observes the operating zone 12 and generates sensor data. In a step S32, the local AI model 18, that has been produced from the common AI model 32, outputs a safety evaluation on the sensor data. This decides whether a safety measure is taken or not. The local AI model 18 has thus taken over the responsibility for safety. The possibility of an alternative monitoring together with the classical safety system has already been mentioned with respect to step S17.

FIG. 6 shows an exemplary flowchart for a distributed training of the common AI model. This largely corresponds to the routine of FIG. 3, with the starting point being an AI model that has already been trained in a distributed manner and that carries out its own safety evaluation. The subsequent training can be iteratively repeated and can be used as a co-running process beside the operation for the constant development and optimization of the AI model.

In a step S31, the first sensor 16 observes the operating zone 12 and generates sensor data. In a step S32, the local AI model 18, that has been produced from the common AI model 32, outputs a safety evaluation on the sensor data. In parallel with this, in a step S33, the classical safety system also monitors the operating zone 12 by the second sensor 22 and outputs a safety evaluation. Alternatively, only one of the steps S32 or S33 is sufficient for safe operation and the annotation of sensor data of the first sensor 16. In a step S34, the local AI model 18 is trained by the annotated sensor data acquired in this manner. A copy of the local AI model 18 is preferably trained so that the previous local AI model 18 remains available in unchanged form for productive operation. It is generally conceivable to train the productive AI model 18 itself; however, this is not uncritical with regard to the safety level to be ensured. In a step S35, the training progresses are transmitted to the orchestration server 28. The further steps S36 to S39 are then analogous to the steps S5 to S7 of FIG. 3, with the difference that the starting point for the new common AI model 32 is the previous common AI model 32 and not a newly initiated or merely pretrained common AI model 32.

Instead of subsequent training the common AI model 32 or in addition to it, local adaptations can also take place at specific locations 10 for their special needs. This is described under the heading “multitask learning” in the literature and can be implemented, for example, in that the front layers of a neural network are taken over in unchanged form by the common AI model 32 and layers further to the rear are individualized with the aid of the local training data. A local AI model 18 can thus, for example, be adapted to a specific sensor arrangement, specific environmental influences, specific object properties, or specific tasks. Since local training data are present for this, the adapted function can additionally be validated for the relevant application cases in a directed manner.

1. A method for a distributed training of a common AI model for a safety monitoring of an operating zone, wherein at least one respective first sensor generates sensor data by monitoring a respective operating zone at a plurality of locations; a respective classical safety system monitors the respective operating zone by at least one respective second sensor at a respective location of the plurality of locations and carries out a safety evaluation; and a respective local AI model is trained with the sensor data and the safety evaluation of the respective location,
wherein the training results of the local AI models are transmitted to an orchestration server; and wherein the orchestration server generates or improves the common AI model using the training results.

2. The method in accordance with claim 1, wherein the method is carried out in accordance with the principle of federated learning.

3. The method in accordance with claim 1,
wherein the orchestration server transmits the common AI model to at least one location.

4. The method in accordance with claim 3,
wherein the orchestration server transmits the common AI model to at least one location where it acts as a local AI model

5. The method in accordance with claim 3,
wherein the local AI model evaluates sensor data recorded by the first sensor there at at least one location to carry out a safety evaluation

6. The method in accordance with claim 5,
wherein the local AI model evaluates sensor data recorded by the first sensor there at at least one location to carry out a safety evaluation and to introduce a safety measure on recognition of a hazard.

7. The method in accordance with claim 3,
wherein the classical safety system furthermore carries out a safety evaluation at least temporarily at the at least one location.

8. The method in accordance with claim 7,
wherein the safety evaluations of the classical safety system and of the local AI model are compared with one another.

9. The method in accordance with claim 8,
wherein a safety measure is initiated when the classical safety system or the local AI model recognizes a hazard.

10. The method in accordance with claim 8,
wherein the local AI model is validated using the comparison.

11. The method in accordance with claim 1,
wherein the common AI model is optimized in an iterative process in that at least one local AI model is subsequently trained with the sensor data and the safety evaluation of the respective location is subsequently trained, training results of the at least one local AI model are transmitted to the orchestration server, and the orchestration server improves the common AI model using the training results.

12. The method in accordance with claim 1,
wherein the first sensor generates image data.

13. The method in accordance with claim 1,
wherein the classical safety system has a radio location system.

14. The method in accordance with claim 1,
wherein the safety evaluation comprises a safe object classification

15. The method in accordance with claim 14,
wherein the safe object classification comprises a person recognition.

16. A safety system for the distributed training of a common AI model for a safety monitoring of an operating zone using an orchestration server and having a plurality of nodes at a respective one of a plurality of locations, wherein the orchestration server has a server processing unit and a first communication interface and the nodes have a respective AI processing unit and a second communication interface so that AI models or training results of AI models can be transmitted over the communication interfaces, and at least one respective first sensor for the generation of sensor data by monitoring a respective operating zone of the location is provided at the locations and a respective classical safety system for monitoring the respective operating zone by at least one respective second sensor and for carrying out a safety evaluation is provided, wherein the respective AI processing unit is configured to train a respective local AI model with the sensor data and the safety evaluation of the respective location, and to transmit training results of the local AI models to the orchestration server, and wherein the server processing unit is configured to generate or to improve the common AI model using the training results.

17. The safety system in accordance with claim 16, wherein the distributed training of the common AI model is carried out in accordance with the principle of federated learning.
